(19) United States
(12) Patent Application Publication
(10) Pub. No.: US 2005/0089610 A1
(43) Pub. Date: Apr. 28, 2005

(54) Method of using oxygen enriched supercritical fluids to disinfect foods

(76) Inventors: James T. C. Yuan, Naperville, IL (US); Kazue Takeuchi, Lombard, IL (US); Vasuhi Rasanayagam, Chicago, IL (US)

Correspondence Address: Linda K. Russell, Esq.;Air Liquide, Ste 1800, 2700 Post Oak Blvd., Houston, TX, 77056, US

(21) Appl. No.: 10/857,261

(22) Filed: May 28, 2004

Related U.S. Application Data
(60) Provisional application No. 60/514,730, filed on Oct. 27, 2003.

(51) Int. Cl. A23K 1/00

(52) U.S. Cl. 426/335

(57) ABSTRACT

A method for treating food is disclosed. The method comprises placing the food in a treatment container maintained at an ambient process temperature and pressure. Next, the gas mixture is injected into the treatment container. The gas mixture comprises about one percent oxygen and about 0.2 to 99 percent of a second gas comprising one gas selected from the group consisting of NO, N₂O, He, H₂, CO, CO₂, N₂, and Noble Gas (e.g., Ar, Kr, Xe, and Ne). The gas mixture is subjected to a treatment temperature and treatment pressure of the gas mixture in the container at a level sufficiently great that at least one gas in the gas mixture is maintained in the supercritical state. The treatment temperature and treatment pressure are maintained for a duration. The food is then ready for packaging.

### CROSS REFERENCE TO RELATED APPLICATION

This application claims the benefit of U.S. Provisional Application No. 60/514,730, filed Oct. 27, 2003.

### BACKGROUND OF THE INVENTION

1. Field of the Invention

This invention relates to the field of high pressure processing (HPP) technology on food applications and, in particular, to using high pressure processing under an oxygen-enriched atmosphere to disinfect foods.

2. Related Art

The primary problems for transporting and storing food products are quality deterioration and microbiological contamination. Quality deterioration can be cosmetic, e.g. food discoloration, or can relate to taste or feel, such as texture degradation during processing or storage. Microbiological contamination of food products can be subgrouped into two categories. Where the initial microbial population is dominated by spoilage microorganisms, food products can spoil and need to be discarded, leading to economic loss. Worse, however, if pathogenic microorganisms present as part of the initial microbial population, they can lead to foodborne illness outbreaks and cause human suffering.

The public has become increasingly aware of the dangers of foodborne illness. Outbreaks such as from Listeria monocytogenes, Salmonella and E. coli O157:H7 have raised food safety regulatory concerns, as well. A report issued from the National Research Council (NRC) in 1999 indicated that approximately about 9,000 human deaths a year occurred from about 81 million annual cases of food poisoning. A recent study completed by the Centers for Disease Control and Prevention (CDC) estimates that foodborne diseases afflict 76 million people, require 325,000 hospitalizations and cause 5,000 deaths annually in the United States. These publications highlight a long felt and unsolved need for more effective means of ensuring safe food production.

Currently, food manufacturers process food using different technologies to kill unwanted microorganisms in food. Treated food then is sent for further processing and/or packaging. One of the processing technologies that has been used is high pressure or ultra-high pressure processing (HPP). HPP applies high pressure to food to preserve the food (improve microbial safety) or change the physical and functional properties of the food. Even though HPP delivers promising results on food processing in general, it poses several concerns.

High pressure processing (HPP) technology on food applications has been studied for many years. Research on equipment and methodology has been conducted to study biocidal efficacy or microbial inactivation and different applications (e.g., maintaining freshness). Generally, HPP is recognized to effectively disrupt microbial cells and deactivate enzymes production in food products.

Supercritical fluid extraction has been used for the extraction application in the food industry since the early 1980's. Due to its benefits over conventional solvent extraction, it is becoming the extraction method of choice for high value compounds in natural products industries such as nutraceuticals, cosmetics and pharmaceuticals.

Supercritical fluid extraction uses carbon dioxide under high pressure to extract components. It is environmentally friendly, non-combustible, leaves no toxic or undesirable residues, and is more selective in the components extracted.

Despite their respective advantages, however, these technologies have not been effectively combined to provide optimal food processing technologies, and many drawbacks in food processing remain unsolved.

Some examples of problems associated with the current HPP food processing technologies are its insufficient biocidal efficacy on spores and its relative ineffectiveness on enzymes. HPP is very effective in destroying vegetative cells of microorganisms, but it is not sufficiently effective on bacterial spores at temperatures lower than about 90° C. and pressures under about 90 psig.

However, when food products are heated to above about 50° C., they start to be detrimentally effected by the heat; the sensory, texture, and nutritional quality of the foods may start to deteriorate.

Thus, a problem associated with food processing techniques that precede the present invention is that they do not provide for the delivery and maintenance of foods without also causing diminished color, brightness, texture, aroma and flavor.

Yet another problem associated with food processing techniques that precede the present invention is that they do not sufficiently sterilize the foods while at the same time maintaining high food quality and desirability.

The present invention seeks to provide food processing techniques that overcome the foregoing problems while providing a simply used, relatively facile technique for food processing.

### SUMMARY OF THE INVENTION

In a preferred embodiment, an oxygen-enriched gas mixture is used with a supercritical treatment of food products to improve food safety and quality. Thus, an oxygen-enriched modified atmosphere is applied to packaged food stuffs (e.g. beverages, prepared foods, fresh produce, meat, poultry, and seafood). This is then followed by applying a pressure treatment to maintain the gas mixtures in a supercritical state. This process applies supercritical fluid as a processing aid.

The process improves food safety and simultaneously maintains sensory quality of the packaged food product. Optionally, an oxygen-enriched modified atmosphere can be applied to the food directly before or during the supercritical fluid treatment.

A method for treating food is disclosed. The method comprises placing the food in a treatment container maintained at an ambient process temperature and pressure. The gas mixture is then injected into the treatment container. The gas mixture comprises at least about one percent oxygen and about 0.2 to 99 percent of a second gas comprising one gas selected from the group consisting of NO, N₂O, He, H₂, CO, CO₂, N₂, and Noble Gas (e.g., Ar, Kr, Xe, and Ne). The gas mixture in the container is subjected to a treatment temperature and treatment pressure sufficiently great that at least one gas in the gas mixture is maintained in the supercritical state. The treatment temperature and treatment pressure are maintained for a duration time. The food is then packaged.

Thus, it is an object of the present invention to provide food processing techniques that facilitate the delivery and maintenance of foods that have not been degraded by high temperature applications, and hence provide foods that have undiminished color, brightness, texture, aroma and flavor while at the same time maintaining food safety.

Yet another object of the present invention is to provide food processing techniques that sufficiently sterilize foods to be secure from spoilage while at the same time maintaining high food quality and desirability.

The present invention seeks to provide food processing techniques that overcome the foregoing problems while providing a relatively facile technique for food processing.

### BRIEF DESCRIPTION OF THE DRAWINGS

In the detailed description that follows, reference will be made to the following figures:

FIG. 1 illustrates data showing the effect of HPP under high oxygen environment.

### DESCRIPTION OF PREFERRED EMBODIMENTS

In a preferred embodiment, an oxygen-enriched modified atmosphere is used in combination with a supercritical fluid treatment to treat foods. Due to their complementary effects, use of the oxygen-enriched modified atmosphere reduces the pressure required (versus traditional HPP) to achieve the equivalent process outcome. It is believed that the preferred embodiment accelerates the inactivation of unwanted microorganisms, such as pathogens, and also provides enhanced quality of the treated food.

The preferred embodiment provides an efficient and unique system to effectively preserve food products. An oxygen-enriched gas mixture and a supercritical processing treatment are combined to provide maximum product safety, extend shelf life and enhance the taste and other subjective measures of food quality. In an alternative preferred embodiment, the packaging container can be vacuumed before application of the process.

The primary treatment incorporates an oxygen-enriched gas mixture into the food and/or the container (barrier or permeable), seals the container with a film (barrier or permeable, if it is a tray type), and treats the packaged food products with supercritical fluid processing technology. More particularly, the process can be performed as follows.

Optionally, a vacuum may first be applied to draw the air out of the food and/or the container. Next, a gas mixture is injected into the food and/or the container. The gas mixture comprises at least one percent oxygen and preferably also comprises at least about 0.2 to 99 percent of a second gas, the second gas being at least one gas selected from the group consisting of NO, N₂O, He, H₂, CO, CO₂, N₂, and Noble Gas (e.g., Ar, Kr, Xe, and Ne). A mixture of these gases may be used and considered a second gas, as well. In a most preferred embodiment, the oxygen and the second gas make up substantially 100 percent of the total gas mixture used. The gas mixture is injected into the food or injected to the packaging surrounding the food, or both.

The pressure for supercritical fluid treatment of packaged food products is at least to the level that at least one gas in the gas mixture is at the supercritical stage. In a preferred range of pressure, this pressure is selected and maintained to be between 30 and 200,000 psig. In an even more preferred range of pressure, this pressure is selected and maintained to be between 30 and 120,000 psig. In a most preferred range of pressure, this pressure is selected and maintained to be between 30 and 70,000 psig.

The temperature during the supercritical fluid treatment is at least to the level that at least one gas in the gas mixture is at the supercritical stage, but less than about 50° C., if possible. In a preferred range of temperature, this temperature is selected and maintained to be between minus 300° C. and 130° C. In an even more preferred range of temperature, this temperature is selected and maintained to be between minus 10° C. and 100° C. In a most preferred range of temperature, this temperature is selected and maintained to be between 0° C. and 70° C. Ideally, the temperature is selected and maintained to be between 0° C. and 90° C

A top-lidding film (particularly where the container provided is a tray type) is provided and the container is sealed. A permeable or barrier film is selected, in accordance with industry standards depending on the food product type.

It is preferred to treat packaged food with a pressure that will bring the gas mixture to the supercritical stage relatively quickly, and it is even more preferred to maintain the packaged food under the supercritical stage conditions for a predetermined period of time. In a preferred embodiment, the supercritical conditions are achieved within an achievement time of one second to ten hours. Supercritical conditions are maintained for a duration time of between one second and ten hours. In an even more preferred embodiment, supercritical conditions are maintained for a duration time of between ten seconds and one hour. In a most preferred embodiment, supercritical conditions are maintained for a duration time of between one minute and thirty minutes. After the supercritical treatment, the gas mixture may be removed.

It is believed that the gas mixture provides an unfavorable microenvironment to microorganisms. It is further believed that the gas mixture generates a biocidal efficacy of the supercritical treatment, as the supercritical fluid itself has no biocidal efficacy. Finally, it is believed that the gas mixture provides an optimal atmospheric environment against chemical degradation or any other quality deterioration (e.g., color, flavor, aroma, appearance, texture, chemical stability) of food products during the supercritical treatment.

The following trials were conducted to illustrate the benefits of oxygen-enriched supercritical fluid on disinfection of food products.

### EXAMPLE 1

Generic Escherichia coli strains (JM101, EC11229, EC6) were grown individually in tryptic soy broth (TSB). Three strains were mixed in equal ratio and used as a cocktail inoculum.

A 15 cm diameter of agar disk (15 g of agar dissolved in de-ionized water, sterilized for 15 minutes, poured on petri dishes and stored at 4° C.) was used a carrier for the inoculum. Each agar disk was inoculated with 0.1 ml of cocktail culture and it was spread evenly using a hockey stick. The disks were air dried under the laminar flow hood for at least 30 minutes. Each disk was placed into a high barrier nylon pouch, vacuumed, flushed with 40 cm³ of appropriate gas mixture, and sealed with a heat sealer. Then each pouch was placed inside another bigger pouch and this outer pouch was vacuum-sealed. Pouches were stored at 2° C. overnight prior to the HPP.

The water-jacketed pressure vessel was preheated to the desired process temperature (40° C.) while the pressure transmitting medium and the samples were pre-equilibrated to the initial temperature in an external water bath (30° C.). Samples were placed in the stainless steel basket along a pressure transfer medium. The vessel was then closed and the pressure was generated by the compression using a piston. Once the pressure reached the target pressure (30,000 psi), it was held at that pressure for a predetermined duration time (15 minutes). At the end of the process time, the pressure was released and samples were cooled immediately by placing them in an ice slurry.

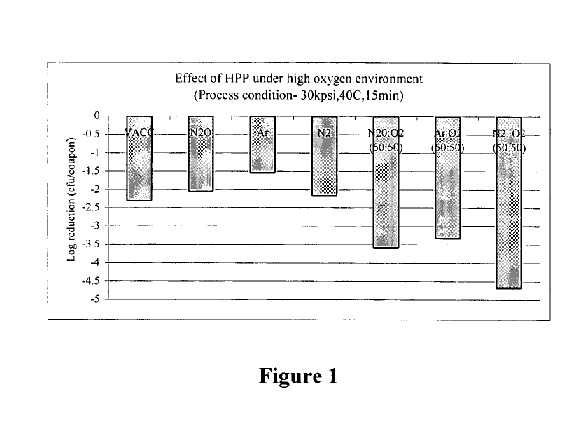

Numbers of surviving cells were determined by plating serially diluted samples on E. coli/Coliform Petrifilm™. Plates were incubated aerobically at 35° C. for 48 hours. Log reductions were determined as differences between counts before and after HPP. The data was compared for before and after the treatment. As shown in FIG. 1, oxygen-enrichment enhanced the biocidal efficacy of supercritical fluid processing.

### EXAMPLE 2

Three strains of generic Escherichia coli (JM101, EC11229, EC6) were grown in tryptic soy broth (TSB) at 35° C. for 24 hours. Three strains were mixed in equal ratio and were diluted in Sorensen's phosphate buffer at pH 7.0 at 2° C.

An inoculum solution was placed in a stainless steel vessel placed in an ice slurry and flushed with each gas at ambient pressure for 10 min. Gas was allowed to set for 3 min. Once the inoculum was flushed with a gas, approximately 10 ml of samples were withdrawn into a pouch made from gas impermeable films. The pouch was sealed immediately with a heat sealer and placed inside of another pouch. The outer pouch was filled with 10 ml water and heat-sealed. The headspace was kept minimum during the sealing of pouches. Pouches were stored at 2° C. overnight prior to the HPP. Pouches of inoculums prior to the gas flushing were also prepared and stored at 2° C.

Sample pouches were processed with Quintus Food Processor Model 6 (Flow International Co. Columbus, Ohio). Some were processed without pulsing at 70,000 psi, and others were processed with pulsing at 70,000 psi. Samples were cooled immediately after HPP by placing them in an ice slurry.

Numbers of surviving cells were determined before and after HPP processing by plating serially diluted samples on E. coli/Coliform Petrifilm™. Plates were incubated aerobically at 35° C. for 48 hours. Log reductions were determined as differences between counts before and after HPP.

TABLE 1
Log reduction of E. coli cells following the HPP process at 70 Kpsi.

| | Log reductions [log cfu/ml] | | |
|---|---|---|---|
| | Process conditions | | |
| | 70 Kpsi at 10° C. | 70 Kpsi at 10° C. | 70 Kpsi at 40° C. |
| Gases | for 2 min | for 5 min | for 2 min |
| O₂ | 6.59 | 8.01 | 6.25 |
| CO₂ | 3.92 | 4.52 | 4.74 |
| N₂O | 3.63 | — | 3.26 |
| Ar | 3.58 | 2.34 | 3.57 |
| H₂ | 3.55 | — | 3.52 |
| HPP control¹ | 2.97 | 3.01 | 3.73 |

¹Inoculum solution was packaged without flushing with a gas.

TABLE 2
Log reduction of E. coli cells following the pulsed HPP process at 70 Kpsi
at 20° C. for 2 min (1 min + 1 min).

| Gases | Log reductions [log cfu/ml] |
|---|---|
| O₂ | 8.04 |
| CO₂ | 5.57 |
| Ar | 5.13 |
| N₂ | 5.16 |
| He | 5.14 |
| HPP Control¹ | 5.10 |

¹Inoculum solution was packaged without flushing with a gas.

Table 1 and 2 results reveal that oxygen provided the best performance among all the gases tested under supercritical condition on reducing E. coli.

Thus, a method for treating food is disclosed. The method comprises placing the food in a treatment container maintained at an ambient process temperature and pressure. Next, a gas mixture is injected into the treatment container. The gas mixture comprises about one percent oxygen and about 0.2 to 99 percent of a second gas comprising one gas selected from the group consisting of NO, N₂O, He, H₂, CO, CO₂, N₂, and Noble Gas (e.g., Ar, Kr, Xe, and Ne). The gas mixture in the container is subjected to a treatment temperature and treatment pressure sufficiently great that at least one gas in the gas mixture is maintained in the supercritical state. The treatment temperature and treatment pressure are maintained for a duration. The food is then packaged.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

1. A method for treating food, the method comprising, in combination:
placing the food in a treatment container;
injecting into the treatment container a gas mixture comprising at least one percent oxygen and about 0.2 to 99 percent of a second gas comprising one gas selected from the group consisting of NO, N₂O, He, H₂, CO, CO₂, N₂, and Noble Gas (e.g., Ar, Kr, Xe, and Ne); and
achieving within an achievement time and maintaining for a duration time a treatment temperature and treatment pressure of the gas mixture in the container to a level sufficiently great that at least one gas in the gas mixture is maintained in the supercritical state.

2. The method of claim 1, whereby the treatment pressure is between about 30 psig and about 200,000 psig.

3. The method of claim 1, whereby the treatment pressure is between about 30 psig and about 120,000 psig.

4. The method of claim 1, whereby the treatment pressure is between about 30 psig and about 70,000 psig.

5. The method of claim 1, whereby the treatment temperature is between about −300° C. and about 130° C. psig.

6. The method of claim 1, whereby the treatment temperature is between about −10° C. and about 100° C. psig.

7. The method of claim 1, whereby the treatment temperature is between about 0° C. and about 70° C.

8. The method of claim 2, whereby the treatment temperature pressure is between about 30 psig and about 200,000 psig.

9. The method of claim 3, whereby the treatment temperature pressure is between about 30 psig and about 120,000 psig.

10. The method of claim 4, whereby the treatment temperature pressure is between about 30 psig and about 70,000 psig.

11. The method of claim 1, whereby the achievement time is between about one second and ten hours.

12. The method of claim 1, whereby the duration time is between about one second and ten hours.

13. The method of claim 11, whereby the duration time is between about one second and ten hours.

14. The method of claim 1, whereby the duration time is between about ten seconds and one hour.

15. The method of claim 1, whereby the duration time is between about one minute and thirty minutes.

16. The method of claim 2, whereby the duration time is between about one second and ten hours.

17. The method of claim 3, whereby the duration time is between about ten seconds and one hour.

18. The method of claim 4, whereby the duration time is between about one minute and thirty minutes.

19. The method of claim 5, whereby the duration time is between about one second and ten hours.

20. The method of claim 6, whereby the duration time is between about ten seconds and one hour.

21. The method of claim 7, whereby the duration time is between about one minute and thirty minutes.

22. A method for treating food, the method comprising, in combination:
placing the food in a treatment container maintained at an ambient process temperature and pressure;
injecting into the treatment container a gas mixture comprising about one percent oxygen and about 0.2 to 99 percent of a second gas comprising one gas selected from the group consisting of NO, N₂O, He, H₂, CO, CO₂, N₂, and Noble Gas (e.g., Ar, Kr, Xe, and Ne);
maintaining for a duration time of between about one minute and thirty minutes a treatment temperature of between about 0° C. and about 70° C. and a treatment pressure of the gas mixture of between about 30 psig and about 70,000 psig in the container; and
packaging the food.
